(19) United States
(12) Patent Application Publication
(10) Pub. No.: US 2006/0077555 A1
(43) Pub. Date: Apr. 13, 2006

(54) Diffuse optical films

(76) Inventors: Ching Wen Chen, Taoyuan City (TW); Shin-Lai S. Lu, Taipei (TW)

Correspondence Address: 3M INNOVATIVE PROPERTIES COMPANY, PO BOX 33427, ST. PAUL, MN, 55133-3427, US

(21) Appl. No.: 10/961,301

(22) Filed: Oct. 8, 2004

(51) Int. Cl. F21V 7/04; H05B 33/00; G02B 5/02; G02B 13/20

(52) U.S. Cl. 359/599; 428/212

(57) ABSTRACT

Diffuse optical films are provided, which include an optical film portion and a light diffusion portion in contact with the optical film portion, the light diffusion portion having rounded depressions disposed on a surface of the light diffusion film portion that faces away from the optical film portion. The optical film portion has an optical characteristic different from optical characteristics of the light diffusion portion. Optical devices including such diffuse optical films and methods of making such diffuse optical films are also provided.

### FIELD OF THE INVENTION

The present invention relates to diffuse optical films, optical devices comprising diffuse optical films, and methods of making diffuse optical films. Particularly, the present invention relates to diffuse optical films having rounded depressions on at least one of their surfaces.

### BACKGROUND

Microprocessor-based devices that include electronic displays for conveying information to a viewer have become nearly ubiquitous. Mobile phones, handheld computers, personal digital assistants, electronic games, car stereos and indicators, public displays, automated teller machines, in-store kiosks, home appliances, computer monitors, and others are all examples of devices that include information displays viewed on a daily basis. Many of the displays provided on such devices are liquid crystal displays (“LCDs”).

Unlike cathode ray tube (CRT) displays, LCDs do not emit light and, thus, require a separate light source for viewing images formed on such displays. Ambient light illumination is sufficient for some applications, but with many LCDs ambient light causes glare and is detrimental to readability. On the other hand, some applications require display viewing under the conditions where ambient illumination is not present or its intensity is insufficient. Thus, in order to improve readability, some LCDs include a source of light located behind the display, which is generally known as “backlight.”

Presently, many popular systems for backlighting LCDs include direct-lit backlights, in which multiple lamps, such as CCFLs, or a single serpentine-shaped lamp are arranged behind the display in the field of view of the user, and edge-lit backlights, in which light sources are placed along one or more edges of a lightguide located behind the display.

Some traditional backlights include one or more enhancement films having prismatic surface structures, such as Vikuiti™ Brightness Enhancement Film (BEF), available from 3M Company. A layer or layers of a reflective polarizer are also typically included into a traditional backlight, such as Vikuiti™ Dual Brightness Enhancement Film (DBEF) or Vikuiti™ Diffuse Reflective Polarizer Film (DRPF), both available from 3M Company. DBEF and/or DRPF, usually placed over BEF, transmit light with a predetermined polarization. Light with a different polarization is reflected back into the backlight, where the polarization state is altered and the light is fed back into the reflective polarizer. This process is usually referred to as “recycling.”

In addition, many traditional direct-lit backlights usually include a thick diffuser plate placed over the lamps in order to hide them from the viewer. Such diffuser plates have large amounts of absorption associated with them, as well as large amounts of back scattering, the effects of which grow exponentially if light-recycling BEF and DBEF films are added to the backlight. To further aid in hiding individual light bulbs from a viewer, the diffuser plates in some traditional backlights have been patterned, which typically resulted in additional losses of light.

Typical traditional direct-lit and edge-lit backlights include one or more diffuser sheets in order to widen the viewing angle and to improve uniformity of output illumination, for example by hiding defects in the constituent components of backlights. Hiding such defects is particularly important in displays that are typically viewed at close distance for extended periods of time. Most traditional backlights also include back reflectors to improve efficient use of light and to facilitate recycling.

Since thin film transistor liquid crystal displays (TFT-LCDs) have advantages of portability, low power consumption, and low radiation, they have been widely used in various portable products, such as notebooks, personal digital assistants (PDA), etc. A backlight source is a key device of TFT-LCDs, which can provide a bright and uniform light distribution to display images.

### SUMMARY OF THE INVENTION

The present disclosure is directed to diffuse optical films, which include an optical film portion and a light diffusion film portion in contact with the optical film portion, the light diffusion portion having rounded depressions disposed on a surface of the light diffusion film portion that faces away from the optical film portion. The optical film portion has an optical characteristic different from optical characteristics of the light diffusion portion.

The present disclosure is also directed to optical devices including a light source and a diffuse optical film. The diffuse optical film includes an optical film portion and a light diffusion film portion in contact with the optical film portion, the light diffusion portion having rounded depressions disposed on a surface of the light diffusion film portion that faces away from the optical film portion. The optical film portion has an optical characteristic different from optical characteristics of the light diffusion portion.

In addition, the present disclosure is directed to methods of making diffuse optical films, which include the steps of providing an optical film portion and applying an ionizing radiation curable material onto a surface of the optical film portion. The methods further include utilizing a bead roll to shape the ionizing radiation curable material while an ionic radiation is applied to cure the ionizing radiation curable material through the bead roll so as to form a light diffusion film portion having rounded depressions on a surface of the light diffusion film portion.

These and other aspects of the diffuse optical films, optical devices comprising the diffuse optical films, and methods of making the diffuse optical films according to the subject invention will become readily apparent to those of ordinary skill in the art from the following detailed description together with the drawings.

### BRIEF DESCRIPTION OF THE DRAWINGS

So that those having ordinary skill in the art to which the subject invention pertains will more readily understand how to make and use the subject invention, exemplary embodiments thereof will be described in detail below with reference to the drawings, wherein:

FIG. 1 is a schematic diagram of a typical TFT-LCD device;

FIG. 2 is a schematic perspective view of an exemplary diffuse optical film according to the present disclosure;

FIG. 3 is a schematic cross-sectional view of an exemplary diffuse optical film according to the present disclosure;

FIG. 4 is a schematic diagram of an optical device including an exemplary diffuse optical film according to the present disclosure;

FIG. 5 is a schematic diagram illustrating an exemplary manufacturing method according to the present disclosure;

FIG. 5A is a schematic cross-sectional view illustrating a portion of a beaded roll;

FIG. 6 shows schematically a first configuration used to test optical films, including an exemplary diffuse optical film according to the present disclosure;

FIGS. 7A-7F represent conoscopic polar graphs obtained using the configuration of FIG. 6;

FIGS. 8A and 8B represent cross-sectional luminance plots obtained using the configuration of FIG. 6;

FIG. 9 shows schematically a second configuration used to test optical films, including an exemplary diffuse optical film according to the present disclosure;

FIGS. 10A-10F represent conoscopic polar graphs obtained using the configuration of FIG. 9; and

FIGS. 11A and 11B represent cross-sectional luminance plots obtained using the configuration of FIG. 9.

### DETAILED DESCRIPTION

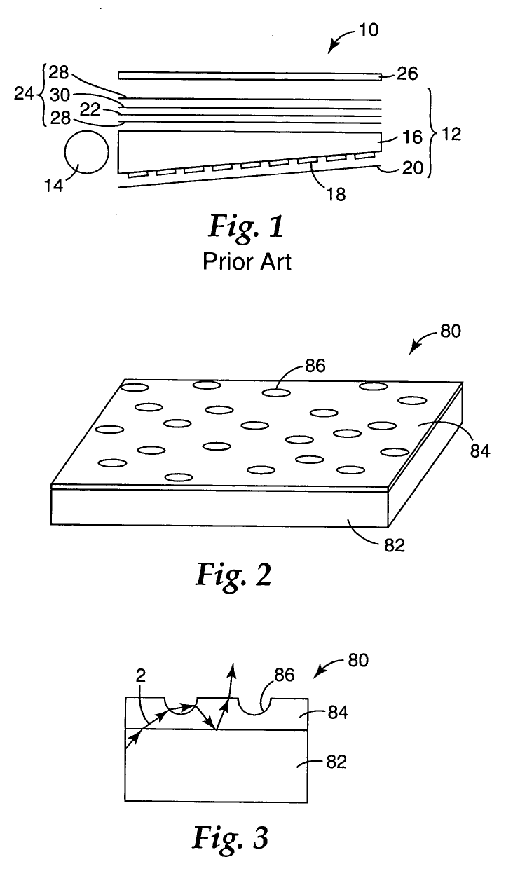

FIG. 1 is a schematic diagram of an optical device 10 including a conventional edge-lit backlight 12. The backlight 12 includes an edge lamp 14, a wedge lightguide 16 with diffuse patterns 18 such as extraction dots, a bottom reflector 20, and an optical film stack 24. In the backlight 12, at least a portion of light from the edge lamp 14 is introduced into the side of the lightguide 16, propagates in the lightguide 16 due to total internal reflection (TIR) from the lightguide's sides, and is extracted from the lightguide 16 through TIR failure or with the aid of the diffuse patterns 18. Then, at least a portion of that light passes through the optical film stack 24 and toward a light-gating device 26, such as an LCD.

Typically, the optical film stack 24 includes one or more films such as diffuser films 28 for providing better uniformity of the light supplied to the light-gating device 26 and then to a viewer, a reflective polarizer film 30 to substantially transmit light of one polarization state and substantially reflect light of a different polarization state, and at least one layer of BEF 22 to enhance on-axis brightness. A variety of reflective polarizer films can be used in the optical film stack. Examples of suitable reflective polarizer film 30 include DBEF and DRPF. The diffuser films 28 are typically placed at the bottom of the optical stack and on top of the optical stack, as shown in FIG. 1. The at least one layer of BEF 22 is typically disposed over the bottom diffuser film 28 and the reflective polarizer film 30 is typically disposed over the at least one layer of BEF 22 and below the top diffuser film 28. The diffuser films 28 are used to improve uniformity of the light supplied to the light-gating device 26, to reduce the appearance of the diffuse patterns 18 on the lightguide 16 and to reduce the appearance of defects that may occur on the films in the optical stack 24, the lightguide 16, or/and the reflector 20, such as scratches and particles.

The present disclosure thus provides diffuse optical films having high light transmittance as well as diffusivity, optical devices containing such optical films and methods of making such optical films. Notably, the diffuse optical films according to the present disclosure may be advantageously combined with other optical films to produce multi-functional optical films. Various optical films are suitable for use in the embodiments of the present disclosure. For example, optical brightness enhancing films as well as filmic reflectors are suitable for use with the appropriate embodiments of the present disclosure, because, at least in some applications, they are likely to benefit from having structures imparted into one or more of their surfaces, for example, to provide a hazy surface, to facilitate lamination to other components, or to prevent the optical film from adhering to adjacent components.

FIG. 2 is a schematic diagram of an exemplary diffuse optical film 80 according to the present disclosure. The diffuse optical film 80 includes an optical film portion 82, which may be an optical brightness enhancing film, such as an optical film that improves performance of a display by facilitating recycling of light having an unwanted characteristic, by redirecting light toward a viewer or by another suitable mechanism, for example, DBEF, DRPF, BEF, a turning film or a volume diffuser, or a filmic reflector, such as a multilayer reflector, for example ESR. The diffuse optical film 80 further includes a light diffusion portion 84 having a plurality of rounded depressions 86 on a surface of the light diffusion portion 84. In accordance with the present disclosure, the optical film portion 82 may be formed integrally with or separately from the light diffusion portion 84. In the latter case the optical film portion 82 may be laminated to the light diffusion portion by a suitable adhesive.

Optical film portions 82 particularly suitable for use in embodiments of the present disclosure have at least one optical characteristic that is different from optical characteristics of the light diffusion film portion 84 alone. For example, the optical film portion having an optical characteristic that is different from the light diffusion portion may manipulate light in a way that is different from the way light is manipulated by the plurality of rounded depressions 86 on the surface of the light diffusion portion 84. Such manipulation may include polarization of transmitted or reflected light, additional diffusion of light or additional redirection of light entering the optical films of the present disclosure. Suitable films having such optical characteristics different from those of the light diffusion portion alone include polarizer films such as multilayer dielectric reflective polarizer films, diffuser films, brightness enhancing films such as BEF, turning films, filmic reflectors such as multilayer dielectric reflectors, and combinations thereof.

In typical embodiments of the present disclosure, the light diffusion film portion 84 is substantially free from light diffusing particles. In some exemplary embodiments, at least some of the rounded depressions 86 are shaped as portions of spherical surfaces, with some rounded depressions being approximately hemispherical. In other exemplary embodiments, at least a substantial amount of the rounded depressions are shaped as portions of spherical surfaces. Depending on the desired properties of the diffuse optical film 80, the rounded depressions 86 may be substantially the same shape and/or size or they may be of at least two substantially different shapes and sizes.

In some exemplary embodiments of the present disclosure, materials for the formation of the light diffusion film portion 84 are transparent curable materials, such as high refractive index resins. Exemplary suitable high refractive index resins include ionizing radiation curable resins, preferably ultraviolet light curable resins, such as those disclosed in U.S. Pat. Nos. 5,254,390 and 4,576,850, the disclosures of which are incorporated herein by reference to the extent they are consistent with the present disclosure. Some known resins suitable for forming the light diffusion portion 84 have refractive indices of about 1.6, 1.65, 1.7 or higher. However, in some exemplary embodiments, the light diffusion portion may be formed from materials having lower refractive indices. In some exemplary embodiments, the refractive index of the light diffusing film portion is higher than that of at least a layer of the optical film portion that is adjacent to the light diffusion portion.

Where the light diffusion portion 84 is formed separately from the optical film portion, the thickness of the light diffusion portion 84 may be as low as about 100 μm, but in some exemplary embodiments it may be as high as about 160 μm. Exemplary diameters of the rounded depressions 86 include about 20 μm, about 60 μm and about 80 μm. In some exemplary embodiments, the depressions 86 may be smaller, but not so small as to cause diffraction effects, or they may be larger, for example 150 μm. In typical embodiments of the present disclosure, the diameters of the rounded depressions 86 should be small enough so as not to be readily apparent to a viewer of the optical device. In some exemplary embodiments, the rounded depressions 86 may be closely packed or they may be spaced apart, depending on a particular application and the nature of the optical film portion 82. In the context of the present disclosure, closely packed rounded depressions may be spaced by about 10 μm or less.

FIG. 3 is a schematic cross-sectional view of an exemplary diffuse optical film 80, illustrating rounded depressions 86. When light incident as illustrated by the arrow 2 onto one side of the diffuse optical film 80 in a direction toward the light diffusion portion 84, the light will usually refract repeatedly in the light diffusion portion 84 at the boundaries of the rounded depressions 86. Thus, the light diffusion portion 84 of the diffuse optical film 80 may aid in producing a more uniform distribution of light exiting the diffuse optical film 80.

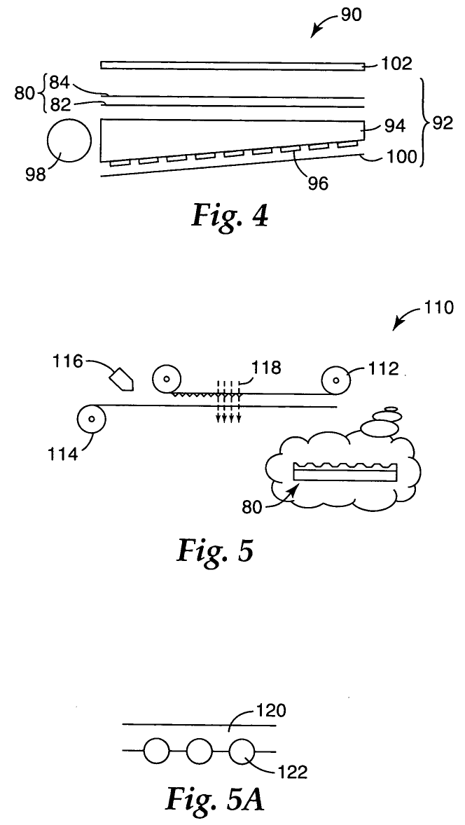

FIG. 4 illustrates schematically an exemplary optical film 80 of the present disclosure used in an optical device 90. The optical device 90 may include a backlight 92 having a lightguide 94, which may include diffuse patterns 96, such as extraction dots disposed on its back side to facilitate light extraction, an edge lamp 98 for supplying light to the lightguide 94, a bottom reflector 100, and the diffuse optical film 80. As explained above, the diffuse optical film 80 includes an optical film portion 82 and a light diffusion portion 84 including rounded depressions 86. Optical film portions 82 particularly suitable for use in such embodiments of the present disclosure include polarizer films, diffuser films, brightness enhancing films, such as BEF, turning films and combinations thereof. In some exemplary embodiments of the present disclosure, the depressions 86 are disposed on a surface of the diffuse optical film 80 facing away from the lightguide 94, but in other exemplary embodiments, the rounded depressions 86 may be disposed on a surface of the diffuse optical film 80 facing the lightguide 94. The optical device 90 may further include a light gating device 102, such as an LCD, and the optical film 80 can be disposed between the lightguide 94 and the light gating device 102.

Exemplary methods and apparatuses for making exemplary diffuse optical films 80 of the present disclosure are described with reference to FIG. 5. FIG. 5 shows schematically an apparatus 110, which may be used in making an exemplary diffuse optical film 80. The apparatus 110 includes a bead roll 112, a roll of an optical film 114, a resin coater 116, and ionizing radiation 118, such as UV radiation. As shown in more detail in FIG. 5A, the bead roll 112 may include a transparent flexible substrate 120 and a plurality of beads 122 embedded into the transparent flexible substrate 120, preferably protruding from the surface of the substrate 120. Suitable beads include beads made of glass, while suitable transparent flexible substrate materials include epoxies. The sizes of beads are selected according to the desired size of the rounded depressions 86. Thus, depending on the desired properties of the light diffusion film portiori 84, the bead roll 112 may include beads of about the same size, beads of at least two substantially different sizes, or beads of more than two substantially different sizes. In some exemplary embodiments, the beads may be closely packed on the substrate.

The exemplary method of making the optical films 80, illustrated in FIGS. 5 and 5A, includes a step of providing an optical film portion 82, such as DBEF, DRPF, BEF or a multilayer dielectric reflector. Then, the optical film portion 82 may be wound on the circumference of an optical film roll 114 while applying (preferably continuously) ionizing radiation curable resin in a fluid state from the resin coater 116, which may be disposed on the underside of the bead roll 112, onto a surface of the optical film portion 82. The bead roll 112 may be then utilized to shape the ionizing radiation curable resin while a predetermined quantity of ionic irradiation 118 is applied from an ionic irradiation device (not shown in FIG. 5) to the ionizing radiation curable resin through the transparent substrate 120 with beads 122 of the bead roll form 112. Thus, the resin may be cured to form the light diffusion film portion 84 having rounded depressions 86 thereon in such a way that the resin is in contact with the optical film portion 82. The optical film portion 82 together with the light diffusion film portion 84 may be then separated from the bead roll 112 so as to form an exemplary optical film 80 of the present disclosure.

According to the present disclosure, the apparatus 110 may be advantageously produced by a modification of a conventional apparatus for forming an optical film with additional layers on both sides. The modification would include replacing a top roll by the bead roll 112, and the bottom roll by the optical film roll 114. Furthermore, the resin can be cured from the bead roll side since the bead roll 112 is ionizing radiation (e.g., UV) permeable. Thus, the exemplary methods described herein would work even with optical films that are ionizing radiation (e.g., UV) proof. Moreover, the ionizing radiation-cured structure of the present disclosure can be easily released from the beaded roll surface without any surface release agents or additional surfactant in resin. Unlike the conventional metal tool, beads can be formed in a roll format that makes it possible to be flexible in production. Consequently, the method and apparatus of the present disclosure for forming the diffuse optical film 80 is simple, stable, and can be used widely even with optical films that are ionizing radiation proof.

### EXAMPLES

The present disclosure will be further illustrated with reference to the following examples.

### Example 1 and Comparative Examples 1 to 3

The diffuse optical film 80 formed by the above-described manufacturing method of the light diffusion portion 84 on DBEF as the optical film portion 82 is used as Example 1 of the present disclosure. Commercially available DBEF films by 3M, particularly DBEF laminated with top and bottom polycarbonate (PC) diffusers (D440™) and DBEF extruded with an outer layer containing diffuse particles (DBEF-M™), were used as Comparative Examples 2 and 3, respectively. A DBEF and a conventional diffuser film without light-diffusing particles are used as Comparative Example 1.

1. Comparison of Haze, Transmittance, and Thickness:

For the aforementioned optical films, the haze (%), the total light transmittance (%), and the thickness (μm) thereof were measured and shown in Table 1.

TABLE 1

| | Haze (%) | Transmittance (%) | Thickness (μm) |
|---|---|---|---|
| Comp. Ex. 1 | 1.2 | 50.0 | 132 |
| Comp. Ex. 2 | 78.8 | 52.0 | 440 |
| Comp. Ex. 3 | 32.4 | 49.6 | 132 |
| Ex. 1 | 97.9 | 61.0 | 260 |

Haze and transmittance were measured according to a standard test method ASTM D1003 using Haze-Gard Plus™ apparatus, available from BYK Gardner Company. In Table 1, the optical film of Example 1 has the highest haze and transmittance than other optical films, and has a smaller thickness than the optical film of the Comparative Example 2 (D440™). Therefore, an exemplary diffuse optical film of the present invention can effectively aid in covering the diffusion patterns on the underside of the lightguide and provide improved luminance distribution and display quality.
2. Comparison of On-Axis Gain in Horizontal and Vertical Directions and Conoscopic Polar Graphs:

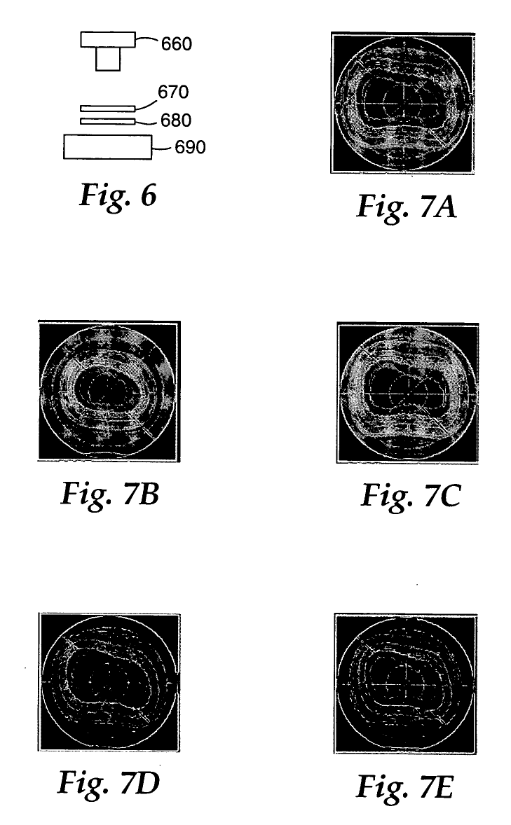

The measurements were first made using a configuration illustrated in FIG. 6. FIG. 6 schematically illustrates a light box 690 providing substantially uniform illumination, an optical film 680 placed over the light box 690, and an LCD panel 670 placed over the optical film 680. A commercially available conoscope 660 was used to observe the performance of several optical films.

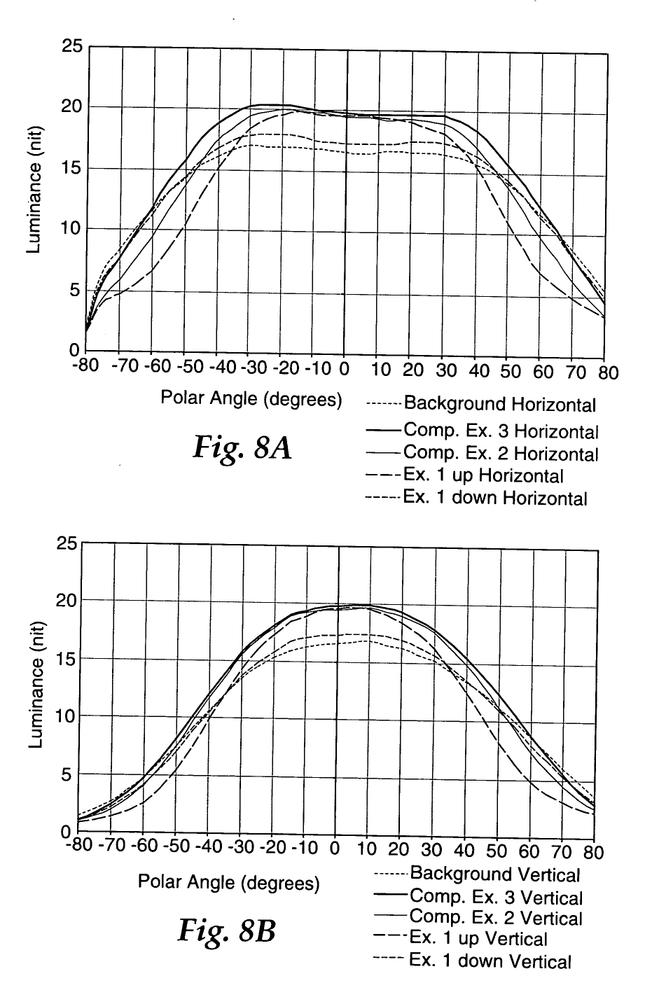

FIGS. 7A-E show conoscopic plots, illustrating angular output distributions of the configuration shown in FIG. 6 with different optical films placed at 680, as compared to a background measurement. In this experiment, the background measurement was obtained from the configuration of FIG. 6 with the optical film 680 removed. FIG. 7A represents the background measurement, FIG. 7B represents the measurement of the diffuse optical film of Example 1 disposed with the depressions facing the LCD panel, FIG. 7C represents the measurement of the diffuse optical film of Example 1 disposed with the depressions facing away from the LCD panel, FIG. 7D represents the measurement of DBEF extruded with an outer layer containing diffuse particles (DBEF-M™) previously used as Comparative Example 3, and FIG. 7E represents the measurement of DBEF laminated with top and bottom PC diffusers (D440™) previously used as Comparative Example 2. FIG. 8A shows luminance cross-section data in the horizontal direction of the plots shown in FIGS. 7A-E, while FIG. 8B shows luminance cross section data in the vertical direction of the plots shown in FIGS. 7A-E.

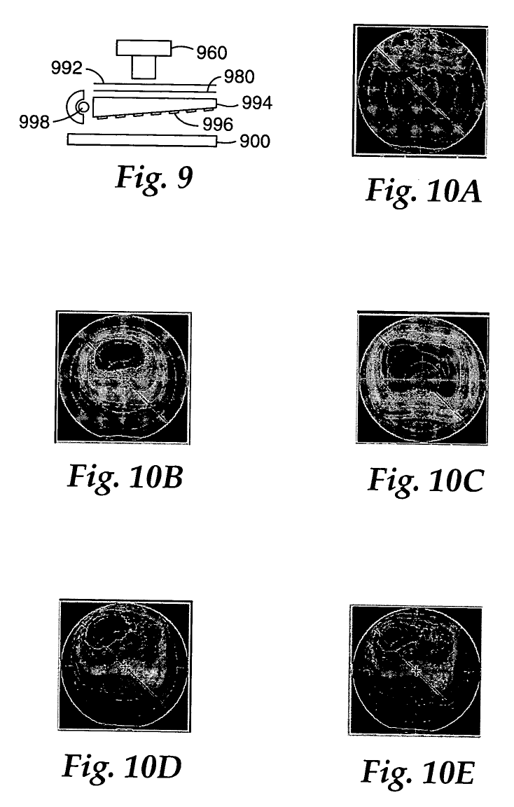

Measurements were then made using a configuration illustrated in FIG. 9. FIG. 9 schematically illustrates an edge lamp 998 coupled to a wedge lightguide 994 having a diffuse extraction pattern 996, a back reflector 900, an optical film 980 placed over the lightguide 994, and an LCD panel 992 placed over the optical film 980. A commercially available conoscope 960 was used to observe the performance of several optical films.

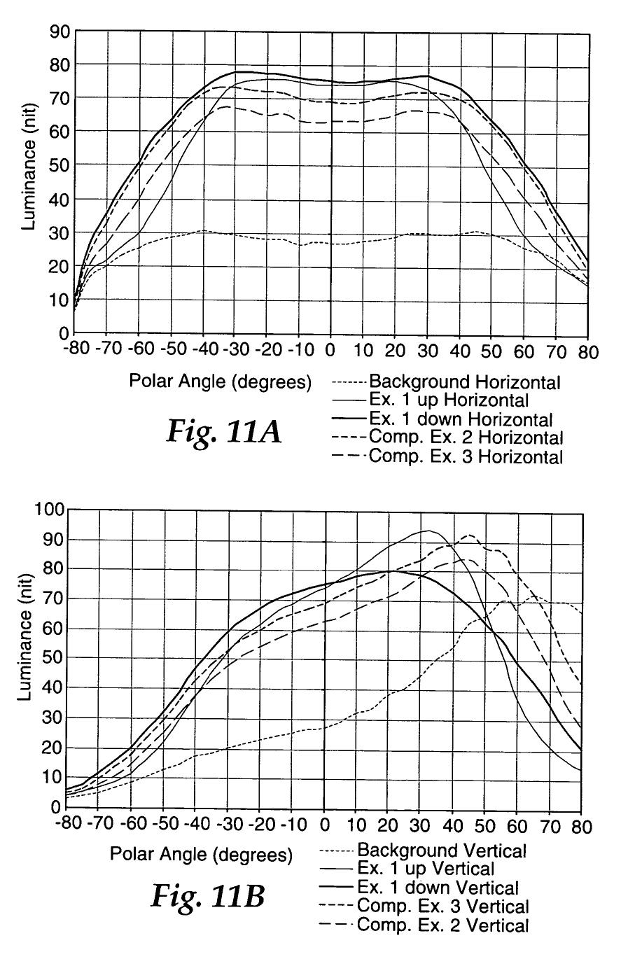

FIGS. 10A-E show conoscopic plots illustrating angular output distributions of the configuration shown in FIG. 9 with different optical films placed at 980, as compared to a background measurement. In this experiment, the background measurement was obtained from the configuration of FIG. 9 with the optical film 980 removed. FIG. 10A represents the background measurement, FIG. 10B represents the measurement of the diffuse optical film of Example 1 disposed with the depressions facing the LCD panel, FIG. 10C represents the measurement of the diffuse optical film of Example 1 disposed with the depressions facing away from the LCD panel, FIG. 10D represents the measurement of DBEF extruded with an outer layer containing diffuse particles (DBEF-M™) previously used as Comparative Example 3, and FIG. 10E represents the measurement of DBEF laminated with top and bottom PC diffusers (D440™) previously used as Comparative Example 2. FIG. 11A shows luminance cross-section data in the horizontal direction of the plots shown in FIGS. 10A-E, while FIG. 11B shows luminance cross section data in the vertical direction of the plots shown in FIGS. 10A-E.

The axial luminance (cd/m²), the maximum luminance (cd/m²), θ of maximum luminance (°), φ of maximum luminance (°), and on-axis gain of each optical film of Example 1 and Comparative Examples 1 to 3 measured using the configuration of FIG. 9 are illustrated in Table 2, along with those of the background measurement.

TABLE 2

| | Axial | | | | |
|---|---|---|---|---|---|
| | Lum. | Max. Lum. | θ of Max. | φ of Max. | On Axis |
| Sample Name | (cd/m²) | (cd/m²) | Lum. (°) | Lum. (°) | Gain |
| Background | 11.4 | 36.8 | 69 | 110 | 1.00 |
| Comp. Ex. 1 | 25.6 | 40.7 | 45 | 120 | 2.25 |
| Comp. Ex. 2 | 26.8 | 42.6 | 52 | 120 | 2.35 |
| Comp. Ex. 3 | 26.2 | 45.0 | 57 | 120 | 2.30 |
| Ex. 1 | 31.1 | 40.1 | 28 | 100 | 2.73 |

In Table 2, the optical film of Example 1 has the highest axial luminance and on-axis gain. Thus, in these exemplary configurations, the optical film of Example 1 has an improved uniformity and more centralized luminance distribution than the background or Comparative Examples 1 to 3.

The optical film of the present disclosure can provide satisfactory luminance and a better light diffusing ability, and can aid in covering the diffusion patterns on the underside of the lightguide. Moreover, exemplary apparatuses of making the optical film of the present disclosure can be obtained by modification of a conventional apparatus, and the method of making the optical film can be used even if the optical film portions are lightproof. Furthermore, the diffuse optical films of the present disclosure can facilitate the elimination or, at least, reducing the number or thickness of the conventional diffusers. Since the general trend in TFT-LCD applications is to decrease the thickness of displays, an integrated film according to the present disclosure, which also may be multi-functional and can have improved brightness and uniform distribution is expected to be desired in future applications.

Those skilled in the art will readily observe that numerous modifications and alterations of the exemplary embodiments of the present disclosure may be made while retaining the teachings of the invention. Accordingly, the above disclosure should be construed as limited only by the metes and bounds of the appended claims.

What is claimed is:

1. A diffuse optical film comprising:
an optical film portion; and
a light diffusion portion in contact with the optical film portion, said light diffusion portion comprising a plurality of rounded depressions disposed on a surface of the light diffusion portion that faces away from the optical film portion;
wherein the optical film portion has an optical characteristic different from optical characteristics of the light diffusion portion.

2. The diffuse optical film of claim 1, wherein the optical film portion is a brightness enhancing film, a diffuser, a turning film or a combination thereof.

3. The diffuse optical film of claim 1, wherein the optical film portion is a multilayer dielectric reflector.

4. The diffuse optical film of claim 1, wherein the light diffusion portion comprises an ionizing radiation curable material.

5. The diffuse optical film of claim 4, wherein the ionizing radiation curable material comprises an ultraviolet curable material.

6. The diffuse optical film of claim 1, wherein the light diffusion portion has a refractive index that is higher than a refractive index of a layer of the optical film portion that is adjacent to the light diffusion portion.

7. The diffuse optical film of claim 1, further comprising an adhesive disposed between the optical film portion and the light diffusion portion.

8. The diffuse optical film of claim 1, wherein at least some of the rounded depressions are shaped as a portion of a spherical surface.

9. The diffuse optical film of claim 1, wherein at least some of the rounded depressions are approximately hemispherical.

10. The diffuse optical film of claim 1 wherein at least some of the rounded depressions are at least about 20 μm in diameter.

11. The diffuse optical film of claim 1, wherein the light diffusion portion comprises pluralities of rounded depressions of at least two substantially different sizes.

12. The diffuse optical film of claim 1, wherein the light diffusion portion comprises pluralities of rounded depressions that are closely packed.

13. An optical device comprising:
a light source; and
a diffuse optical film of claim 1.

14. The optical device of claim 13, wherein the plurality of rounded depressions of the diffuse optical film are disposed on a surface of the diffuse optical film that faces away from a surface receiving light from the light source.

15. The optical device of claim 13, wherein the plurality of rounded depressions of the diffuse optical film are disposed on a surface of the diffuse optical film that receives light from the light source.

16. The optical device of claim 13, further comprising a lightguide optically coupled to the light source.

17. The optical device of claim 16, wherein the lightguide is a wedge lightguide that permits light to enter therein from an incident face thereof and to leave from an outgoing face that is at an angle to the incident face.

18. The optical device of claim 13, further comprising a light-gating device, disposed to receive light transmitted or reflected by the diffuse optical film.

19. A method of making a diffuse optical film, comprising the steps of:
providing an optical film portion;
applying an ionizing radiation curable material onto a surface of the optical film portion; and
utilizing a bead roll to shape the ionizing radiation curable material while an ionic radiation is applied to cure the ionizing radiation curable material through the bead roll so as to form a light diffusion portion having a plurality of rounded depressions on a surface of the light diffusion portion.

20. The method of claim 19, wherein the optical film portion is wound on a circumference of a roll while applying the ionizing radiation curable material on a surface of the optical film portion.

21. The method of claim 19, further comprising the step of separating the optical film portion together with the light diffusion portion from the bead roll.

22. The method of claim 19, wherein the ionizing radiation curable material comprises an ultraviolet curable material.

23. The method of claim 19, wherein the bead roll comprises pluralities of beads of at least two different sizes.

24. The method of claim 19, wherein the beads on the bead roll are closely packed.

25. The method of claim 19, wherein the bead roll comprises a transparent flexible substrate and a plurality of glass beads fixed on the transparent substrate.
